(19) United States
(12) Patent Application Publication
(10) Pub. No.: US 2022/0342847 A1
(43) Pub. Date: Oct. 27, 2022

(54) DELETING SNAPSHOTS VIA COMPARING FILES AND DELETING COMMON EXTENTS

(71) Applicant: VMware, Inc., Palo Alto, CA (US)

(72) Inventors: Pranay Singh, Palo Alto, CA (US); Wenguang Wang, Palo Alto, CA (US); Nitin Rastogi, Palo Alto, CA (US)

(73) Assignee: VMware, Inc., Palo Alto, CA (US)

(21) Appl. No.: 17/231,640

(22) Filed: Apr. 15, 2021

(51) Int. Cl. G06F 16/11; G06F 16/176; G06F 16/188; G06F 16/16

(52) U.S. Cl. CPC G06F 16/128; G06F 16/1767; G06F 16/188; G06F 16/162

(57) ABSTRACT

The present disclosure is related to methods, systems, and machine-readable media for deleting snapshots. A deletion process can be performed responsive to receiving a request to delete a snapshot of a virtual computing instance (VCI) in a file system. The deletion process can include performing a first file comparison between the snapshot and a previous snapshot to determine first extents exclusive to the snapshot, performing a second file comparison between the snapshot and a subsequent snapshot to determine second extents exclusive to the snapshot, performing a third file comparison between the first extents and the second extents to determine common extents, wherein the common extents are common to the first extents and the second extents, and deleting the common extents from the file system.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

In many instances, it may be desirable to delete a snapshot. For instance, deleting a snapshot can free up storage space. Snapshots may utilize a copy-on-write policy that involves sharing storage, which, while being space efficient, makes deletion problematic. Previous approaches to deleting snapshots incur costs associated with querying the usage of extents in a reference count table. Additionally, previous approaches can overload system resources. For instance, in previous approaches snapshot deletion may compete with the normal workload of a system for input/output (IO) central processing unit (CPU) and/or memory resources.

### BRIEF DESCRIPTION OF THE DRAWINGS

FIG. 1 is a diagram of a host and a system for deleting snapshots according to one or more embodiments of the present disclosure.

FIG. 2A illustrates an example file system B-tree according to one or more embodiments of the present disclosure at a first time instance.

FIG. 2B illustrates the example file system B-tree at a second time instance.

FIG. 3 illustrates two example file system B-trees, each belonging to a snapshot of a given VDFS sub-volume according to one or more embodiments of the present disclosure.

FIG. 4 is a flow chart associated with deleting snapshots according to one or more embodiments of the present disclosure.

FIG. 5 illustrates a snapshot chain according to one or more embodiments of the present disclosure.

FIG. 6 is a diagram of a system for deleting snapshots according to one or more embodiments of the present disclosure.

FIG. 7 is a diagram of a machine for deleting snapshots according to one or more embodiments of the present disclosure.

FIG. 8 is a flow chart illustrating one or more methods for deleting snapshots according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

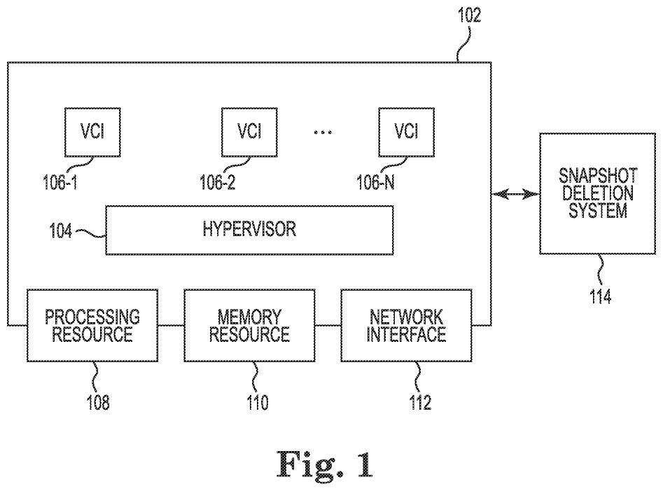

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

A VCI snapshot (referred to herein simply as “snapshot”) is a copy of a disk file of a VCI at a given point in time. A snapshot can preserve the state of a VCI so that it can be reverted to at a later point in time. The snapshot can include memory as well. In some embodiments, a snapshot includes secondary storage, while primary storage is optionally included with the snapshot. A snapshot can store changes from a parent snapshot (e.g., without storing an entire copy of the parent snapshot). Snapshots provide filesystems the ability to take an instantaneous copy of the filesystem. An instantaneous copy allows the restoration of older versions of a file or directory from an accidental deletion, for instance. Snapshots also provide the foundation for other disaster recovery features, such as backup applications and/or snapshot-based replication. A snapshot includes one or more extents. An extent is a contiguous area of storage reserved for a file in a file system. An extent can be represented, for instance, as a range of block numbers. Stated differently, an extent can include one or more data blocks that store data. A snapshot references extents by file as a part of a file block map. A file comparison (e.g., a diff) can be performed between two or more snapshots. A typical use of snapshot diff would be to track file objects that have changed between two snapshots.

A Virtual Distributed File System (VDFS) is a hyper converged distributed file system. VDFS runs at the hypervisor level and it allows multiple clients to connect to it from different VCIs. VDFS uses a copy-on-write (CoW) B-tree to support scalable snapshots. Snapshots can be created instantaneously and there is no architecture limit of the maximum number of snapshots. VDFS also provides an efficient API to calculate what files and directories on a file system have changed since a past snapshot. Because the order of the file system events do not matter, the snapshot diff acts as the “file system event log” and can satisfy VDFS use cases of file system events. A snapshot can be considered a copy of a file-share (sub-volume) as it preserves data and metadata for the entire file-share, so one can create a point in time read-only image of the file system. Many sub-volumes can be created in a single VDFS volume.

In previous approaches, snapshot deletion in a CoW-based B-tree makes use of an auxiliary data structure called a reference count table to keep track of extents used. However, there is an extra lookup cost when querying the usage of an extent in a reference count table. Deletion of a snapshot, can begin with a process termed “hollowing out.” In such a process, all extents that are part of the CoW B-tree are scanned and their usage is queried in the reference count table. If usage is found to be 1 the extents are deleted. In contrast, embodiments of the present disclosure do not make use of a reference count table, thereby avoiding the extra lookup costs. In order to track the usage of extents, embodiments herein can utilize a snapshot diff algorithm that includes a three-way diff in order to determine which extents are owned by the snapshot undergoing deletion. Snapshot diff can track the pages of the B-tree that have been changed (e.g., since a previous snapshot).

Snapshot deletion can be a long-running process, during which numerous IO operations can be involved. In previous approaches, this may impact the system's performance as the normal workload of a system may compete for IO, CPU and/or memory resources with snapshot deletion. The competition problem becomes more acute with greater numbers of VDFS servers running on a single physical host. Embodiments herein provide a framework allowing asynchronous snapshot deletion, wherein only one snapshot can be deleted at a time. The number of snapshot deletions can be further limited across VDFS server instances so that only a fixed number of snapshot deletions can progress on a physical host. This strategy makes snapshot deletion less onerous by reducing the use of CPU, TO, and/or memory resources to perform the deletion job. As a result, the performance of the system is improved.

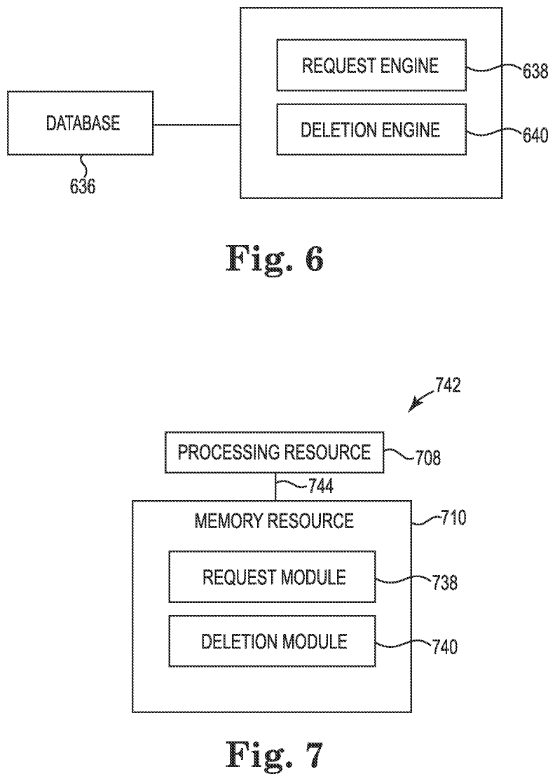

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 608 in FIG. 6. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for deleting snapshots according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a snapshot deletion system 114. An example of the snapshot deletion system is illustrated and described in more detail below. In some embodiments, the snapshot deletion system 114 can be a server, such as a web server.

VDFS uses lazy refcounting of file system B-tree and embedded reference counting to track the ownership of data blocks. The embedded reference count is a shared bit per extent (variable size data block) that tracks the ownership of an extent together with the page stamping of the node. Thus, the same extent may be considered shared when read by one snapshot and owned when read by a different snapshot. In some embodiments, the value of shared bit 0 (e.g., refcount 0) represents owner access and shared bit 1 represents shared access. If the snapshot Id of the root node and the leaf node is the same, the shared bit is unchanged, but if the snapshot Id is greater than the page stamp of the leaf node, the shared bit will have a value of 1, representing shared access.

Ownership of an extent can be indicated by a shared bit value of “0” and sharing of an extent can be indicated by a shared bit value of “1.” This shared bit is used by the live sub-volume to determine whether the extent can be written, or if a new extent allocation is required during overwrite. Each node is stamped with a snapshot Id. This scheme of ownership of extent is based on the fact that if the root node of the file system B-tree is the same as the leaf node of the file system B-tree, the root node and the leaf node were updated and/or created with the same snapshot Id, and are therefore of the same generation. However, if the stamping (snapshot Id) of the leaf node and the root node differ, the root node and the leaf node of the B-Tree are of different generations. If so, the B-tree does not own the extents, but has shared access. Thus, any potential overwrite would include the allocation of a new extent.

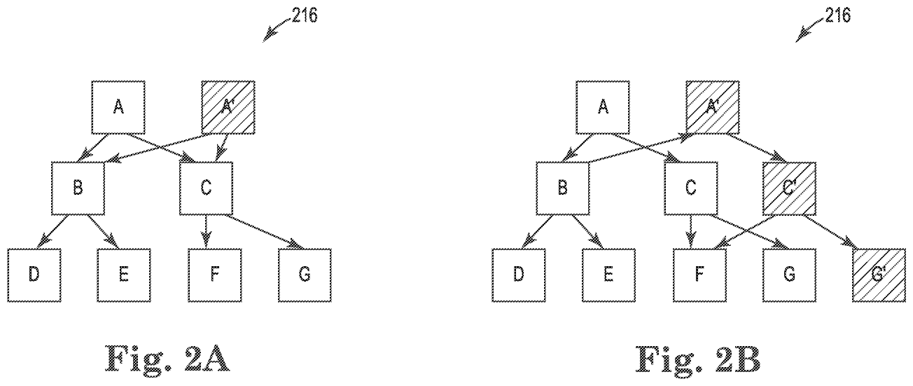

FIG. 2A illustrates an example file system B-tree 216 according to one or more embodiments of the present disclosure at a first time instance. FIG. 2B illustrates the example file system B-tree 216 at a second time instance. FIGS. 2A and 2B may be cumulatively referred to herein as “FIG. 2.” As shown in FIG. 2, the B-tree 216 includes an old root node A and new root node A′. The latest version of the file system (e.g., new writes) would point to root node A′, whereas the older root node A would be pointed to by snapshot. A live sub-volume represents the share of the file system where files are created and deleted, whereas snapshots are accessed via a special directory “/.vdfs/snapshot”. As new writes happen to the live sub-volume, the two B-trees start to differ. Thus, as shown in FIG. 2B, nodes C′ and G′ have been added as child nodes of root node A′.

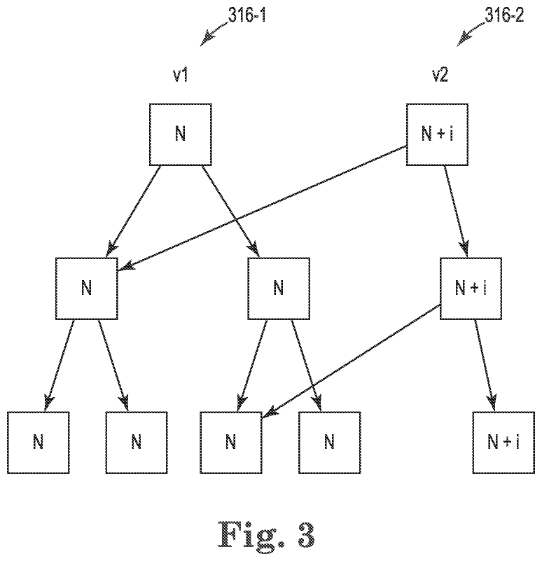

FIG. 3 illustrates two example file system B-trees, each belonging to a snapshot of a given VDFS sub-volume according to one or more embodiments of the present disclosure. The file system B-trees illustrated in FIG. 3 are a first tree 316-1 and a second tree 316-2. The first tree 316-1 may be alternatively referred to as “snapshot 1” and the second tree 316-2 may be alternatively referred to as “snapshot 2.” In FIG. 3, squares represent the page/node of the B-tree and the label on each page is a pagestamp associated with that page. B-tree implementation enforces the fact that pagestamps of internal and leaf nodes cannot be greater than the root of the B-tree. A B-tree diff involves traversing internal nodes that differ to determine the file objects (e.g., files, directories, extended attributes, extents, etc.) that have been changed between file system B-trees belonging to the two snapshots: snapshot 1 and snapshot 2.

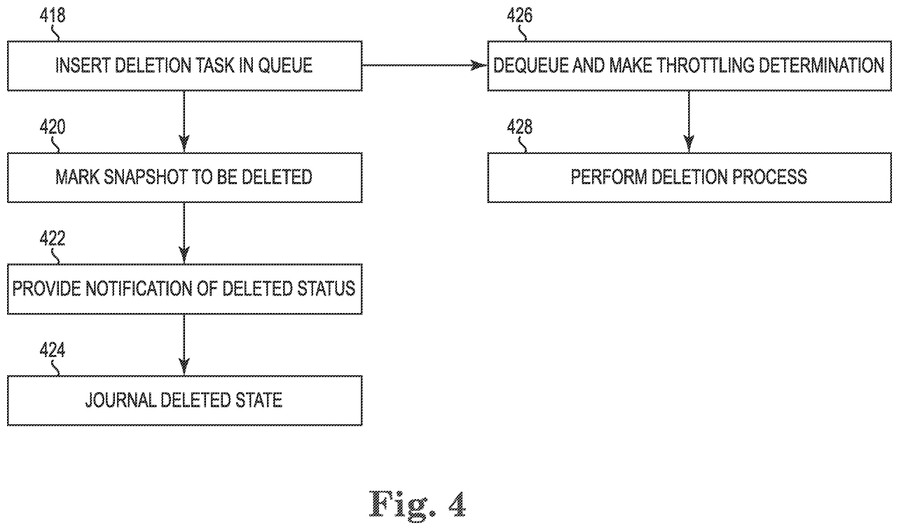

FIG. 4 is a flow chart associated with deleting snapshots according to one or more embodiments of the present disclosure. VDFS provides an asynchronous interface to facilitate fast and concurrent snapshot deletion. As described further below, the state of snapshot deletion can be preserved. Preserving the state of snapshot deletion allows embodiments herein to be resilient to system and/or snapshot crashes. Additionally, as discussed further below, snapshot deletion can be throttled on a single node.

Some portions of snapshot deletion are synchronous. The synchronous portions can ensure that the system has registered snapshot deletion, after which a designated snapshot will be deleted even if the system crashes. Blocks 418, 420, 422, and 424 are synchronous portions of snapshot deletion in the flow chart illustrated in FIG. 4. At 418, a deletion task is inserted in a deletion queue. The task can be inserted responsive to receiving a request to delete a snapshot. Such a request can be made by a user, for instance, though embodiments of the present disclosure are not so limited. At 420, the snapshot to be deleted can be marked (e.g., “DELETE PENDING”) and a notification of the deleted status (e.g., “DELETED,” “DELETE PENDING”) can be provided. The provision of such a notification can be made via a graphical user interface (GUI), for instance. At 424, the deleted state can be journaled. Journaling, as referred to herein, includes recording a history of actions executed by a database management system used to guarantee ACID (atomicity, consistency, isolation, durability) properties over crashes and/or hardware failures. In some embodiments, only metadata is journaled. In some embodiments, stored data and related metadata is journaled. Once a snapshot has been marked for deletion, the deletion can occur in the background (e.g., the asynchronous portions, discussed below). In the meantime, a user can access data associated with a snapshot.

Some portions of snapshot deletion are asynchronous. The asynchronous portions perform the more involved process of deleting the data associated with the snapshot. At 426, the deletion task is dequeued and a throttling determination is made. Throttling deletion can include slowing a rate of deletion if the usage of system resources by the deletion exceeds a threshold. For instance, there can be multiple VDFS server instances hosted on a node inside a VDFS server process. A snapshot deletion thread (or fiber) can run for each VDFS server instance. Each running thread can utilize memory and/or CPU resources. Throttling can reduce the number of snapshot deletion threads that are running concurrently. Throttling snapshot deletion threads can reduce an extent to which IO is affected by deletion processes. In some embodiments, a counter can be provided. In some embodiments, a counting semaphore can be provided to count the quantity of concurrent deletion threads. In an example where 3 snapshot threads are allowed to run (e.g., a semaphore count threshold of 3), the following brief pseudocode for throttling can be used:

```
Semaphore value set to 3
snapshotDeletionLoop ( ) {
  While (true) {
    Dequeue snapshotID to delete
    P( ) block // → block if count == 0
    DoDeleteOfSnapshot ( )
    V( )
  }
}
```

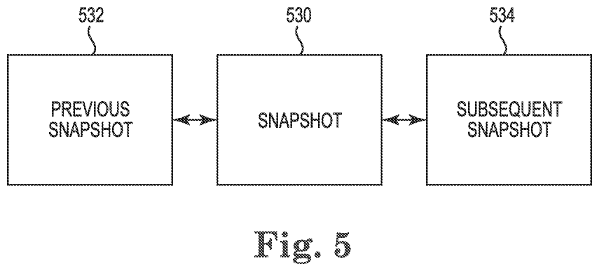

At 428, a deletion process is performed. The deletion process is discussed in more detail in connection with FIG. 5.

FIG. 5 illustrates a snapshot chain according to one or more embodiments of the present disclosure. In the snapshot chain, an earliest snapshot (herein referred to as a “previous snapshot 532”) is followed by a snapshot to be deleted (herein referred to as a “snapshot 530”), which is followed by a later snapshot (herein referred to as a “subsequent snapshot 534”). As previously discussed, snapshots in VDFS employ CoW, so snapshot deletion can include determining which extents are “owned” by snapshot 530, which extents are “owned” by previous snapshot 532, and which snapshots are “owned” by subsequent snapshot 534. Snapshot deletion is a single thread that can undergo different states to remove extents owned by the snapshot 530. A first state can be referred to as GET_EXTENTS. A second state can be referred to as DIFF_FREE_EXTENTS.

GET_EXTENTS can include determining whether an extent in snapshot 530 is referred to by either previous snapshot 532 or subsequent snapshot 534. This state can get the extent by performing a two-way B-tree diff in pairs. B-tree diff performs a depth first traversal and makes uses of page stamping to traverse pages with different page stamps. In order to delete the snapshot 530, a first B-tree diff can be performed between the previous snapshot 532 and the snapshot 530. Then a second B-tree diff can be performed between the subsequent snapshot 534 and the snapshot 530. The first B-tree diff can determine a batch of extents between the snapshot 530 and the previous snapshot 532 that have been created and/or updated. The second B-tree diff can take a range of a batch of extents between the subsequent snapshot 534 and the snapshot 530 and determine any extents that have been inserted (e.g., not present in a newer tree) and/or updated. In some cases, the diffs will determine overlapping extents. In some cases, the diffs will determine non-overlapping extents. The example discussed herein involves overlapping extents, but it is to be appreciated that embodiments herein can process non-overlapping extents in a similar manner.

Horizon, as referred to herein, is the end of an extent. Stated differently, a horizon is the end of the file offset of an extent. In an example, the horizon is 1000. Embodiments herein can determine that the horizon of the snapshot to be deleted (here, snapshot 530 (Snap #2)) and the horizon of its neighbor (here, previous snapshot 532 (Snap #1)) matches:

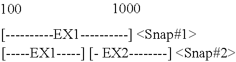

This can be followed by performing a diff to determine what is solely owned by snapshot 530, which will return:

[-EX2--------]

and which can be stored in CurrenPrevIntervalList. The same logic can be followed to consider overlapping extents between the snapshot 530 and the subsequent snapshot 534 (Snap #3):

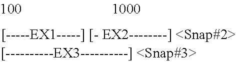

This can be followed by performing a diff to determine what is solely owned by the snapshot 530, which will return:

[-----EX1-----] [-EX2--------]

and which can be stored in CurrenNextIntervalList.

DIFF_FREE_EXTENTS can include receiving the two lists CurrenPrevIntervalList and CurrenNextIntervalList and determining what is common between these two lists. What is determined to be common between the two lists can be deleted. For example, in:

[-----EX1-----] [-EX2--------]

[-EX2--------]

the common extent is [-EX2--------], so [-EX2--------] can be deleted.

Once the snapshot B-tree is hollowed out, the B-tree can be deleted by performing a depth-first traversal and deleting subtrees with a reference count (refcount) of 1.

A brief pseudocode of the algorithm is presented below, wherein snapId1 is a root stamp of the previous snapshot 532, snapId is a root stamp of the snapshot 530, and snapId2 is a root stamp of the subsequent snapshot 534.

```
DeleteSnapshot(snapId) {
  snapId1 is root stamp of previous snapshot
  snapId is root stamp of snapshot to be deleted
  snapId2 is root stamp of next snapshot
  snapId1Iterator = Iterator(snapId1)
  snapIdIterator = Iterator(snapId)
  snapIdIterator = Iterator(snapId2)
  while (snapIdIterator) {
    pagestamp = GetStamp(snapIdIterator)
    if (pagestamp < snapId) {
      continue;
    }
    if (pagestamp == snapId) {
      pageNumber = GetPageNumber(snapIdIterator)
      //Adaptive, CoW changes small in next snapshot, maintain
ChangeList
      if (changeList && (pageNumber not in ChangeList or snapId2)) {
        continue;
      }
    }
    Get objectId from snapIdIterator
    BEGIN (transaction)
    {
      // Checkpoint objId
      ExtentList1 = Find extents for object Id in snapId1
      ExtentList = Find extents for object Id in snapId
      ExtentList2 = Find extents for object Id in snapId2
      MergeDiffAndFreeExtent(ExtentList1, ExtentList, ExtentList2)
    } COMMIT (transaction)
  }
}
//Shows an array of three different key value pairs representing extent list
//that are merged so that extent belonging to current is obtained shown
in [symbol]   .
MergeDiffAndFreeExtent(ExtentList1, ExtentList, ExtentList2)
{
  ExtentList1 [ ---------) [----------)
  ExtentList [-----) [symbol]
  ExtentList2 [----------------------------------------------------)
  Freed

[symbol]

}
```

Re-starting the deletion process (e.g., after a crash) could potentially lead to a double-freeing of blocks and associated inefficiencies. Therefore, when an extent is freed, embodiments of the present disclosure can update a checkpoint. A checkpoint can store details such as object Id, type, snapshot Id, etc. In some embodiments, updating a checkpoint includes removing an old checkpoint and inserting a new checkpoint. This can be performed as a part of the transaction (e.g., for atomicity). During recover after a system crash, the checkpoint(s) can be scanned, and once the most recent checkpoint is determined, snapshot deletion can be resumed at that checkpoint. After a snapshot is deleted (e.g., when the deletion process is complete), the checkpoint can be removed.

FIG. 6 is a diagram of a system 614 for deleting snapshots according to one or more embodiments of the present disclosure. The system 614 can include a database 636 and/or a number of engines, for example request engine 638 and/or deletion engine 640, and can be in communication with the database 636 via a communication link. The system 614 can include additional or fewer engines than illustrated to perform the various functions described herein. The system 614 can represent program instructions and/or hardware of a machine (e.g., machine 742 as referenced in FIG. 7, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 638 can include a combination of hardware and program instructions that is configured to receive a request to delete a snapshot of a VCI in a file system. In some embodiments, the deletion engine 640 can include a combination of hardware and program instructions that is configured to perform a deletion process responsive to receiving the request. The deletion process can include, for instance, performing a first file comparison between the snapshot and a previous snapshot to determine first extents exclusive to the snapshot, performing a second file comparison between the snapshot and a subsequent snapshot to determine second extents exclusive to the snapshot, performing a third file comparison between the first extents and the second extents to determine common extents, wherein the common extents are common to the first extents and the second extents, and deleting the common extents from the file system.

FIG. 7 is a diagram of a machine for deleting snapshots according to one or more embodiments of the present disclosure. The machine 742 can utilize software, hardware, firmware, and/or logic to perform a number of functions. The machine 742 can be a combination of hardware and program instructions configured to perform a number of functions (e.g., actions). The hardware, for example, can include a number of processing resources 708 and a number of memory resources 710, such as a machine-readable medium (MRM) or other memory resources 710. The memory resources 710 can be internal and/or external to the machine 742 (e.g., the machine 742 can include internal memory resources and have access to external memory resources). In some embodiments, the machine 742 can be a VCI. The program instructions (e.g., machine-readable instructions (MRI)) can include instructions stored on the MRM to implement a particular function (e.g., an action such as performing a deletion process). The set of MRI can be executable by one or more of the processing resources 708. The memory resources 710 can be coupled to the machine 742 in a wired and/or wireless manner. For example, the memory resources 710 can be an internal memory, a portable memory, a portable disk, and/or a memory associated with another resource, e.g., enabling MM to be transferred and/or executed across a network such as the Internet. As used herein, a “module” can include program instructions and/or hardware, but at least includes program instructions.

Memory resources 710 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 708 can be coupled to the memory resources 710 via a communication path 744. The communication path 744 can be local or remote to the machine 742. Examples of a local communication path 744 can include an electronic bus internal to a machine, where the memory resources 710 are in communication with the processing resources 608 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 744 can be such that the memory resources 710 are remote from the processing resources 708, such as in a network connection between the memory resources 710 and the processing resources 708. That is, the communication path 744 can be a network connection. Examples of such a network connection can include a local area network (LAN), wide area network (WAN), personal area network (PAN), and the Internet, among others.

As shown in FIG. 7, the MRI stored in the memory resources 710 can be segmented into a number of modules 738, 740 that when executed by the processing resources 708 can perform a number of functions. As used herein a module includes a set of instructions included to perform a particular task or action. The number of modules 738, 740 can be sub-modules of other modules. For example, the deletion module 740 can be a sub-module of the request module 738 and/or can be contained within a single module. Furthermore, the number of modules 738, 740 can comprise individual modules separate and distinct from one another. Examples are not limited to the specific modules 738, 740 illustrated in FIG. 7.

Each of the number of modules 738, 740 can include program instructions and/or a combination of hardware and program instructions that, when executed by a processing resource 708, can function as a corresponding engine as described with respect to FIG. 6. For example, the request module 738 can include program instructions and/or a combination of hardware and program instructions that, when executed by a processing resource 708, can function as the request engine 638, though embodiments of the present disclosure are not so limited.

The machine 742 can include a request module 738, which can include instructions to receive a request to delete a snapshot of a VCI in a file system. The machine 742 can include a deletion module 740, which can include instructions to perform a deletion process responsive to receiving the request. The deletion process can include, for instance, performing a first file comparison between the snapshot and a previous snapshot to determine first extents exclusive to the snapshot, performing a second file comparison between the snapshot and a subsequent snapshot to determine second extents exclusive to the snapshot, performing a third file comparison between the first extents and the second extents to determine common extents, wherein the common extents are common to the first extents and the second extents, and deleting the common extents from the file system.

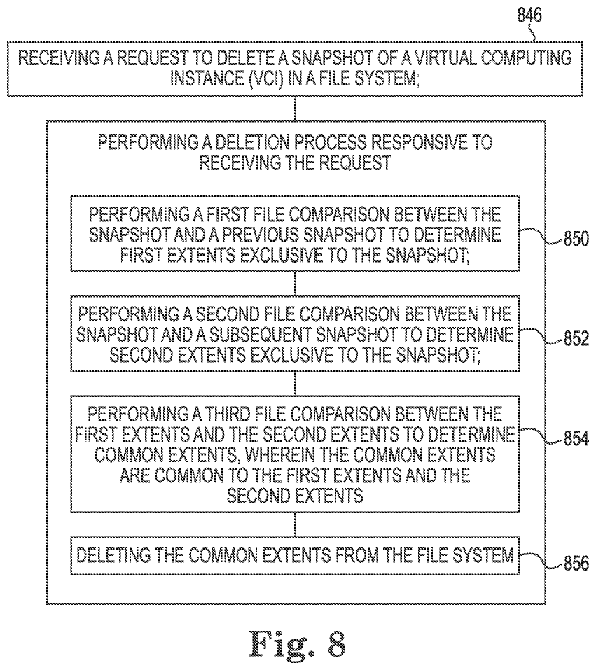

FIG. 8 is a flow chart illustrating one or more methods for deleting snapshots according to one or more embodiments of the present disclosure. The method can include, at 846, receiving a request to delete a snapshot of a VCI in a file system. In some embodiments, the method can include placing a deletion task associated with deleting the snapshot in a deletion queue responsive to receiving the request. The method can include, at 848, performing a deletion process responsive to receiving the request. In some embodiments, the method can include providing a notification of a deleted status of the snapshot before performing the deletion process. As shown in FIG. 8, performing the deletion process can include, at 850, performing a first file comparison between the snapshot and a previous snapshot to determine first extents exclusive to the snapshot. Performing the deletion process can include, at 852, performing a second file comparison between the snapshot and a subsequent snapshot to determine second extents exclusive to the snapshot. Performing the deletion process can include, at 854, performing a third file comparison between the first extents and the second extents to determine common extents, wherein the common extents are common to the first extents and the second extents. Performing the deletion process can include, at 856, deleting the common extents from the file system. In some embodiments, the method can include deleting nodes of a tree associated with the snapshot that have a reference count of 1.

In some embodiments, the method can include throttling the deletion process based on a quantity of concurrent deletion processes exceeding a quantity threshold. In some embodiments, the method can include inserting a checkpoint during the deletion process. In some embodiments, the method can include resuming the deletion process from the checkpoint during a system recovery following a system crash.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a request to delete a snapshot of a virtual computing instance (VCI) in a file system; and
performing a deletion process responsive to receiving the request, the deletion process comprising:
performing a first file comparison between the snapshot and a previous snapshot to determine first extents exclusive to the snapshot;
performing a second file comparison between the snapshot and a subsequent snapshot to determine second extents exclusive to the snapshot;
performing a third file comparison between the first extents and the second extents to determine common extents, wherein the common extents are common to the first extents and the second extents; and
deleting the common extents from the file system.

2. The method of claim 1, wherein the method includes placing a deletion task associated with deleting the snapshot in a deletion queue responsive to receiving the request.

3. The method of claim 1, wherein the method includes providing a notification of a deleted status of the snapshot before performing the deletion process.

4. The method of claim 1, wherein the method includes throttling the deletion process based on a quantity of concurrent deletion processes exceeding a quantity threshold.

5. The method of claim 1, wherein the method includes deleting nodes of a tree associated with the snapshot that have a reference count of 1.

6. The method of claim 1, wherein the method includes inserting a checkpoint during the deletion process.

7. The method of claim 6, wherein the method includes resuming the deletion process from the checkpoint during a system recovery following a system crash.

8. A non-transitory machine-readable medium having instructions stored thereon which, when executed by a processor, cause the processor to:
receive a request to delete a snapshot of a virtual computing instance (VCI) in a file system; and
perform a deletion process responsive to receiving the request, wherein the instructions to perform the deletion process comprise instructions to:
perform a first file comparison between the snapshot and a previous snapshot to determine first extents exclusive to the snapshot;
perform a second file comparison between the snapshot and a subsequent snapshot to determine second extents exclusive to the snapshot;
perform a third file comparison between the first extents and the second extents to determine common extents, wherein the common extents are common to the first extents and the second extents; and
delete the common extents from the file system.

9. The medium of claim 8, including instructions to place a deletion task associated with deleting the snapshot in a deletion queue responsive to receiving the request.

10. The medium of claim 8, including instructions to provide a notification of a deleted status of the snapshot before performing the deletion process.

11. The medium of claim 8, including instructions to throttle the deletion process based on a quantity of concurrent deletion processes exceeding a quantity threshold.

12. The medium of claim 8, including instructions to delete nodes of a tree associated with the snapshot that have a reference count of 1.

13. The medium of claim 8, including instructions to insert a checkpoint during the deletion process.

14. The medium of claim 13, including instructions to resume the deletion process from the checkpoint during a system recovery following a system crash.

15. A system, comprising:
a request engine configured to receive a request to delete a snapshot of a virtual computing instance (VCI) in a file system; and
a deletion engine configured to perform a deletion process responsive to receiving the request, the deletion process comprising:
performing a first file comparison between the snapshot and a previous snapshot to determine first extents exclusive to the snapshot;
performing a second file comparison between the snapshot and a subsequent snapshot to determine second extents exclusive to the snapshot;
performing a third file comparison between the first extents and the second extents to determine common extents, wherein the common extents are common to the first extents and the second extents; and
deleting the common extents from the file system.

16. The system of claim 15, wherein the request engine is configured to place a deletion task associated with deleting the snapshot in a deletion queue responsive to receiving the request.

17. The system of claim 15, wherein the deletion engine is configured to provide a notification of a deleted status of the snapshot before performing the deletion process.

18. The system of claim 15, wherein the deletion engine is configured to throttle the deletion process based on a quantity of concurrent deletion processes exceeding a quantity threshold.

19. The system of claim 15, wherein the deletion engine is configured to delete nodes of a tree associated with the snapshot that have a reference count of 1.

20. The system of claim 15, wherein the deletion engine is configured to insert a checkpoint during the deletion process.
